(19) United States
(12) Patent Application Publication
(10) Pub. No.: US 2014/0025570 A1
(43) Pub. Date: Jan. 23, 2014

(54) READABLE INDICIA FOR BILL PAYMENT

(71) Applicants: Alicia C. Jones, Fort Mill, SC (US); Matthew A. Calman, Charlotte, NC (US); David M. Grigg, Rock Hill, SC (US)

(72) Inventors: Alicia C. Jones, Fort Mill, SC (US); Matthew A. Calman, Charlotte, NC (US); David M. Grigg, Rock Hill, SC (US)

(73) Assignee: Bank of America Corporation, Charlotte, NC (US)

(21) Appl. No.: 13/554,036

(22) Filed: Jul. 20, 2012

(51) Int. Cl. G06Q 20/14

(52) U.S. Cl. 705/40

(57) ABSTRACT

Embodiments of the invention are directed to systems, methods and computer program products for processing readable indicia for bill payment. An exemplary system is configured to: receive information associated with readable indicia associated with a bill; and process the readable indicia to initiate one or more options to schedule payment for the bill, wherein the one or more options comprise a first option to pay the bill immediately, a second option to schedule payment of the bill at a predetermined time in the future, and a third option to establish an electronic link to the merchant in order to schedule periodic payment of the bill.

### BACKGROUND

There is a need to simplify the process of scheduling payment of a bill.

### BRIEF SUMMARY

Embodiments of the invention are directed to systems, methods and computer program products for processing readable indicia for bill payment. An exemplary apparatus for processing readable indicia for paying a bill associated with a merchant comprises: a memory; a processor; and a computing module stored in the memory, executable by the processor, and configured to: receive information associated with readable indicia associated with the bill; and process the readable indicia to initiate one or more options to schedule payment for the bill, wherein the one or more options comprise a first option to pay the bill immediately, a second option to schedule payment of the bill at a predetermined time in the future, a third option to establish an electronic link to the merchant in order to schedule periodic payment of the bill, and a fourth option to present or send a reminder about the bill at a selected date in the future.

In some embodiments, the readable indicia comprises information associated with the merchant and information associated with the bill.

In some embodiments, the readable indicia comprises an alias associated with the merchant.

In some embodiments, the readable indicia comprises information associated with a financial institution account or a payment card.

In some embodiments, the readable indicia comprises information associated with configuring the financial institution account or an account associated with the payment card based on a selected option to schedule payment for the bill, and the module is further configured to: receive a user's selection of an option to schedule payment for the bill; and configure the financial institution account or an account associated with the payment card based on selected option.

In some embodiments, the module is further configured to receive a user's selection of an option to schedule payment for the bill; and initiate scheduling payment for the bill based on the selected option.

In some embodiments, the module is further configured to process the readable indicia to initiate an option to switch from paper-based billing to paperless billing.

In some embodiments, the readable indicia comprises a Quick Response (QR) code.

In some embodiments, the readable indicia is comprised in a tag that transmits information wirelessly.

In some embodiments, the apparatus comprises a portable mobile communication apparatus that comprises an image-capturing component, and an image of the readable indicia is captured by the portable mobile communication apparatus, and the processing occurs either inside or outside the portable mobile communication apparatus.

In some embodiments, the readable indicia comprises electronic readable indicia.

In some embodiments, the electronic readable indicia is transmitted via at least one of email, text message, or multimedia message.

In some embodiments, the electronic readable indicia is dynamically generated based on a user's selection of an option to schedule payment for the bill.

In some embodiments, the readable indicia comprises physical readable indicia, wherein the physical readable indicia is printed on paper.

In some embodiments, the readable indicia comprises a first readable indicia and a second readable indicia, and when the module receives first information associated with the first readable indicia, the module is configured to not simultaneously receive second information associated with the second readable indicia.

In some embodiments, the module is further configured to receive authentication credentials associated with the payment of the bill; and the module configured to process the readable indicia is further configured to process the authentication credentials.

In some embodiments, the authentication credentials are first authentication credentials, second authentication credentials are comprised in the readable indicia, and the module is further configured to extract the second authentication credentials from the readable indicia; and determine whether the first authentication credentials match the second authentication credentials.

In some embodiments, the module is configured to determine whether the authentication credentials match second authentication credentials accessed by the apparatus.

In some embodiments, a method for processing readable indicia for paying a bill associated with a merchant is provided. The method comprises receiving information associated with readable indicia associated with a bill; and processing the readable indicia to initiate one or more options to schedule payment for the bill, wherein the one or more options comprise a first option to pay the bill immediately, a second option to schedule payment of the bill at a predetermined time in the future, a third option to establish an electronic link to the merchant in order to schedule periodic payment of the bill, and a fourth option to present a reminder about the bill at a selected date in the future.

In some embodiments, a computer program product for processing readable indicia for processing readable indicia for paying a bill associated with a merchant is provided. The computer program product comprises a non-transitory computer-readable medium comprising a set of codes for causing a computer to: receive information associated with readable indicia associated with a bill; and process the readable indicia to initiate one or more options to schedule payment for the bill, wherein the one or more options comprise a first option to pay the bill immediately, a second option to schedule payment of the bill at a predetermined time in the future, a third option to establish an electronic link to the merchant in order to schedule periodic payment of the bill, and a fourth option to present a reminder about the bill at a selected date in the future.

### BRIEF DESCRIPTION OF THE DRAWINGS

Having thus described embodiments of the invention in general terms, reference will now be made to the accompanying drawings, where:

FIG. 1 is a flowchart illustrating a general process flow for processing readable indicia for bill payment, in accordance with embodiments of the present invention; and

FIG. 2 is a block diagram illustrating technical components of a system for processing readable indicia for bill payment, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for processing readable indicia for bill payment. As used herein, the readable indicia comprises a code (e.g., barcode, Quick Response (QR) code, etc.).

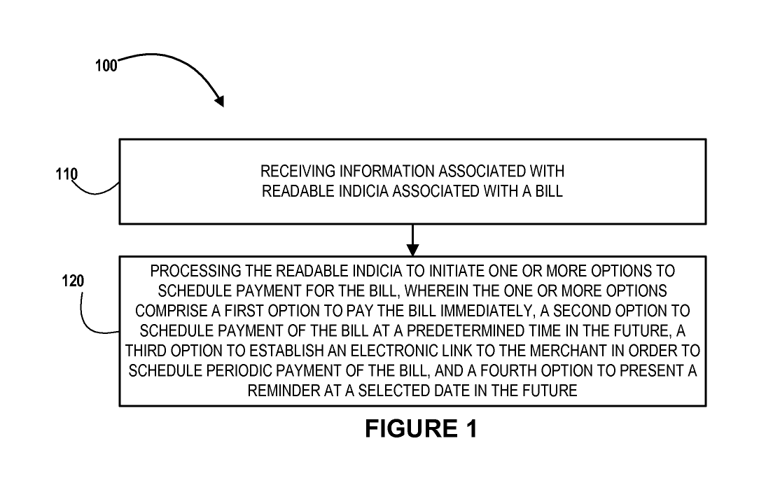

Referring now to FIG. 1, a general process flow 100 is provided for processing readable indicia for bill payment. At block 110, the method comprises receiving information associated with readable indicia associated with a bill.

A merchant sends a bill to a user (e.g., a customer). The bill may be transmitted in physical form (e.g., via email) or in electronic form (e.g., via email, text or multimedia message, etc.). The bill comprises readable indicia. The readable indicia may comprise any kind of one-dimensional or two-dimensional code. In some embodiments, the readable indicia comprises visual indicia, e.g., a barcode, a Quick Response (QR) code, etc. Therefore, the user may use a portable mobile communication device (“mobile device”) that comprises an image-capturing component (e.g., a camera) to capture the image of the readable indicia. In some embodiments, this readable indicia is stored in the mobile device. In other embodiments, this readable indicia is automatically transmitted to an external server.

The readable indicia may comprise any indicia, visual or non-visual, where information associated with the indicia is receivable or readable (e.g., scannable) by the mobile device. For example, the readable indicia is comprised in a tag (e.g., radio frequency identification (RFID) tag, near field communication (NFC) tag, etc.). A user may bring a mobile device in close proximity to the tag in order to receive information (e.g., readable indicia) associated with the tag.

The readable indicia may comprise information associated with the merchant (e.g., merchant's financial institution account that receives bill payment amount), information associated with the user (e.g., user's financial institution account or payment card account linked to payment of the bill, bill payment history, etc.), information associated with the bill (e.g., amount of bill, bill due date, past due bill amount, minimum payment due, bill pre-payment amount etc.).

In some embodiments, the readable indicia comprises an alias associated with the merchant. For example, the alias may comprise a phone number, email address, social networking identification information, or other contact information associated with the merchant. Therefore, the user's mobile device receives information associated with the readable indicia in order to initiate bill payment to the merchant's alias. The financial institution (e.g., a system in network communication with user's mobile device) receives information associated with the readable indicia, determines that the alias is associated with the merchant, and routes the user's bill payment to the merchant (e.g., an account associated with the merchant). In some embodiments, the alias is a one-time alias that can be used by the user only once for making a bill payment. The one-time alias expires after the user makes a bill payment. Additionally, the alias may be configured so that no other user can use the alias for making their bill payment. In embodiments where the bill is an electronic bill, at least one of the readable indicia or the alias may be generated dynamically after the user selects a particular bill payment option or bill payment method. For example, if the user makes a selection to pay the full amount due via text message immediately, a readable indicia is dynamically generated that comprises a text message alias associated with the merchant and that is configured with the full amount and configured for immediate payment. As a further example, if the user makes a selection to pay half the amount due via email on the payment due date, a readable indicia is dynamically generated that comprises an email alias associated with the merchant and that is configured with half the amount due and configured for payment on the due date.

In some embodiments, the electronic or paper bill comprises a single readable indicia. In some embodiments, the readable indicia may be processed by at least one of the mobile device or the external server to determine a link (e.g., a hyperlink) associated with the readable indicia. The user interface of the mobile device may present the link and may prompt the user to visit the link. The link may transport the user to a user interface page for initiating the process of paying the bill. The user interface page may prompt the user to select one or more options to schedule payment for the bill. The one or more options may comprise a first option to pay the bill immediately, a second option to schedule payment of the bill at a predetermined time in the future, a third option to establish an electronic link to the merchant in order to schedule periodic payment of the bill, a fourth option to remind the user again at a predetermined time in the future, etc.

In other embodiments, the electronic or paper bill comprises multiple readable indicia. Each readable indicia (e.g., visual indicia) may be associated with a different link. Each link may be associated with one of the options described herein to schedule payment for the bill. In some embodiments, each link may be associated with a different bill payment amount, wherein a first bill payment amount is less than the amount due, a second bill payment amount is equal to the amount due, a third bill payment amount is greater than the amount due, etc. In some embodiments, on a paper bill, each readable indicia may be covered with a seal (e.g., an opaque seal). The user selects the readable indicia that the user wishes to scan or capture an image of by removing the seal and exposing the readable indicia. In some embodiments, for an electronic bill, the user's mobile device may receive information from only one readable indicia at a time. For example, each readable indicia is covered with an electronic seal. The user selects the readable indicia that the user wishes to scan or capture an image of by selecting an option to remove the electronic seal associated with that readable indicia. Therefore, the electronic bill enables exposure of only one readable indicia at a time. In some embodiments, each of the readable indicia on an electronic bill is dynamically generated after a user selects a particular option to pay a bill.

When the user selects the option to pay the bill immediately, the amount of funds is deducted from the user's financial institution account on the same day and a transfer of funds is initiated from the user's financial institution account to the merchant's financial institution account on the same day or within a few days. Alternatively, when the user selects the option to pay the bill immediately, the user's payment card information (e.g., credit card, debit card, etc.) is used to pay the bill immediately. The user may have previously configured the financial institution account or the payment card to be associated with the bill. Therefore, the readable indicia received from the merchant comprises information associated with the user's financial institution account or payment card. Additionally, the readable indicia received from the merchant comprises information associated with the merchant (e.g., destination account associated with bill payment) so that the payment can be transmitted to the merchant. Additionally, the readable indicia may comprise information for configuring the user's financial institution account or payment card account to pay the bill immediately. Therefore, the user may not need to input any information apart from selecting the option to pay the bill immediately. Therefore, the readable indicia enables the user to pay the bill immediately using just a single click or selection.

When the user selects the second option to pay the bill on a predetermined date in the future (e.g., the due date of the bill or some other user-selected date prior to the due date), the amount of funds is deducted from the user's financial institution account on the predetermined date and a transfer of funds is initiated from the user's financial institution account to the merchant's financial institution account on the predetermined date. Alternatively, when the user selects the option to pay the bill on a predetermined date in the future, the user's payment card information (e.g., credit card, debit card, etc.) is used to pay the bill on the predetermined date in the future. The user may have previously configured the financial institution account or the payment card to be associated with the bill. Therefore, the readable indicia received from the merchant comprises information associated with the user's financial institution account or payment card. Additionally, the readable indicia received from the merchant comprises information associated with the merchant (e.g., destination account associated with bill payment) so that the payment can be transmitted to the merchant. Additionally, the readable indicia may comprise information for configuring the user's financial institution account or payment card account to pay the bill at the predetermined time in the future. Therefore, the user may not need to input any information apart from selecting the option to automatically pay the bill on the predetermined date in the future. Therefore, the readable indicia enables the user to automatically pay the bill on the predetermined date in the future using just a single click or selection.

When the user selects the third option to establish an electronic link to the merchant in order to schedule periodic payment of the bill, the user's financial institution account or payment card (e.g., credit card, debit card, etc.) is electronically linked to the merchant (or to the user's account (e.g., utilities account) associated with the merchant) such that the user's financial institution account or payment card account automatically receives the bill. Additionally, when the user selects the third option, the user may also be presented with an option to automatically pay the bill using funds from the user's financial institution account or using the user's payment card on a particular date each month (e.g., a user-selected date, the date the bill is received, the due date of the bill, etc.). If the user does not select a date for periodic payment of the bill, a default date may be automatically established (e.g., a few days before the due date) by the information comprised in the readable indicia. Therefore, the readable indicia received from the merchant comprises information associated with the merchant (e.g., destination account associated with bill payment) so that the user's financial institution account or payment card account can be configured to automatically receive periodic bills and automatically pay the bills on a user-selected date or a default date. Additionally, the readable indicia may comprise information for configuring the user's financial institution account or payment card account to periodically receive and pay the bill. Therefore, in some embodiments, the user may not need to input any information apart from selecting the option to establish an electronic link to the merchant in order to schedule periodic payment of the bill. Therefore, the readable indicia enables the user to establish an electronic link to the merchant in order to schedule periodic payment of the bill using just a single click or selection.

When the user selects the fourth option to remind the user about the bill at a predetermined time in the future, the system is configured to send or present a reminder to the user about the bill at a predetermined time in the future. In some embodiments, the system may enable the user to select the reminder date (e.g., remind in 5 days, remind on a selected date, or the like). The reminder may be sent via email, text message, social networking message, or the like.

In some embodiments, the user receives a paper bill. When the mobile device or an external server receives and processes information associated with the readable indicia, the mobile device's user interface may present an option to switch from paper-based billing to paperless billing. When the user selects the option, the user's billing from that point forward changes from paper-based billing to paperless billing.

In some embodiments, at block 110, the method additionally comprises receiving authentication credentials associated with the bill payment. In some embodiments, in response to receiving the readable indicia, the mobile device initiates an authentication prompt (e.g., at the link described above) for receiving the authentication credentials from the user. For example, the authentication prompt may comprise a prompt or challenge question for which the user knows the answer. These authentication credentials may have been previously received from the merchant separately from the readable indicia. For example, the merchant may have sent a personal identification number (“PIN”) code to the user via mail, email, text or multimedia message, etc. As a further example, the user may have previously logged onto the merchant's website in order to set up authentication credentials associated with bill payment.

Subsequently, the user inputs authentication credentials onto a user interface of the mobile device. In some embodiments, this input may comprise entering a password. In some embodiments, this input may comprise entering an alias. For example, the alias may comprise a phone number, email address, or social networking identification information associated with the user. In other embodiments, this input may comprise entering an answer to a question. In still other embodiments, this input may comprise selecting a picture. In some embodiments, the received authentication credentials are stored in the mobile device. In other embodiments, the received authentication credentials are automatically transmitted to an external server.

At block 120, the method comprises processing the readable indicia to initiate one or more options to schedule payment for the bill. These options have been described previously. In embodiments where the readable indicia is stored in the mobile device, the processing of the readable indicia occurs in the mobile device. In embodiments where the readable indicia is transmitted to an external server, the processing of the readable indicia occurs outside the mobile device, i.e., at the external server. In some embodiments, the processing comprises comparing the information associated with the readable indicia to information stored in at least one of the mobile device or the external server to determine whether to enable the user to schedule payment of the bill based on a bill payment option selected by the user.

As described previously, in some embodiments, the user is prompted to enter authentication credentials on the mobile device user interface. The user may be prompted to enter authentication credentials prior to initiating one or more options to schedule payment of the bill. In such embodiments, the one or more options to schedule payment of the bill are presented after at least one of the mobile device or the external server successfully processes the authentication credentials. In other embodiments, the one or more options to schedule payment of the bill are presented prior to prior to prompting the user to enter authentication credentials.

In some embodiments, the method, at block 120, further comprises processing the authentication credentials. In embodiments where the authentication credentials are stored in the mobile device, the processing of the authentication credentials occurs in the mobile device. In embodiments where the authentication credentials are transmitted to an external server, the processing of the authentication credentials occurs outside the mobile device, i.e., at the external server. The processing comprises comparing the authentication credentials to information stored in at least one of the mobile device or the external server.

In some embodiments, authentication credentials are comprised in the readable indicia. Therefore, the authentication credentials input by the user are compared to the authentication credentials extracted from the readable indicia. In other embodiments, the authentication credentials are not comprised in the readable indicia. In such embodiments, the authentication credentials input by the user are compared to information (e.g., authentication credentials) stored in at least one of the mobile device or external server or accessed by at least one of the mobile device or external server from an external datastore.

If the mobile device or the external server determines a match between the authentication credentials input by the user and the authentication credentials either extracted from the readable indicia or stored in at least one of the mobile device or external server, the bill payment option selected by the user is processed.

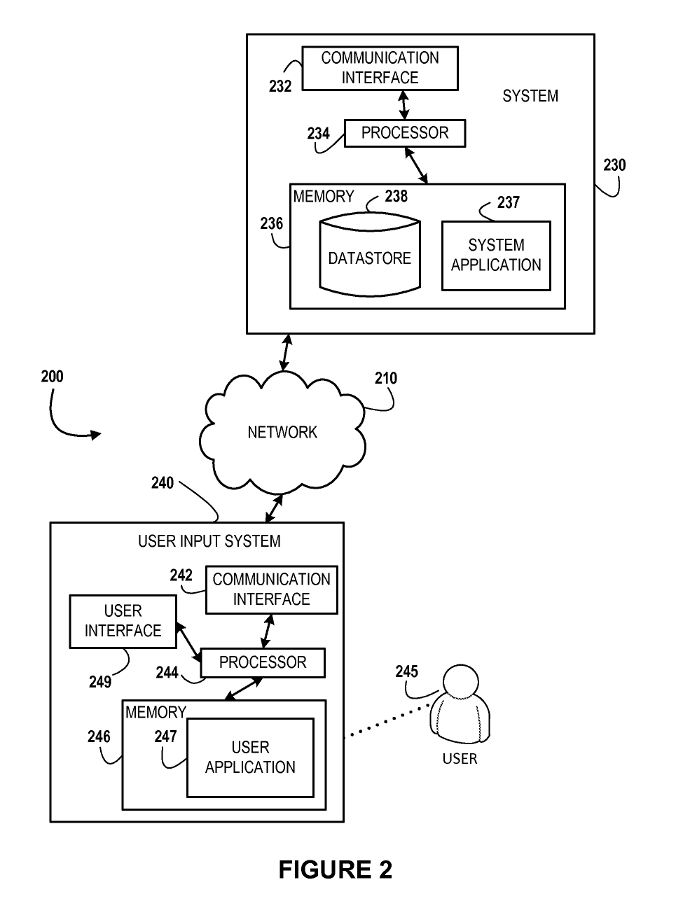

Referring now to FIG. 2, FIG. 2 presents an exemplary block diagram of the system environment 200 for implementing the process flow 100 described in FIG. 1, in accordance with embodiments of the present invention. As illustrated, the system environment 200 includes a network 210, a system 230, and a user input system 240. Also shown in FIG. 2 is a user 245 of the user input system 240. The user input system 240 may be a mobile device described herein. The user 245 may be a person who uses the user input system 240 to execute a user application 247. The system 230 may be the external server described herein. The user application 247 and/or the system application 237 may incorporate one or more parts of the process flow 100 or any other function described herein.

As shown in FIG. 2, the system 230, and the user input system 240 are each operatively and selectively connected to the network 210, which may include one or more separate networks. In addition, the network 210 may include a local area network (LAN), a wide area network (WAN), and/or a global area network (GAN), such as the Internet. The network may also include a mobile telecommunication network. It will also be understood that the network 210 may be secure and/or unsecure and may also include wireless and/or wireline and/or optical interconnection technology.

The user input system 240 may include any computerized apparatus that can be configured to perform any one or more of the functions of the user input system 240 described and/or contemplated herein. For example, the user 245 may use the user input system 240 to transmit and/or receive information or commands to and from the system 230. In some embodiments, for example, the user input system 240 may include a personal computer system, a mobile computing device, a personal digital assistant, a mobile phone, a network device, and/or the like. As illustrated in FIG. 2, in accordance with some embodiments of the present invention, the user input system 240 includes a communication interface 242, a processor 244, a memory 246 having an user application 247 stored therein, and a user interface 249. In such embodiments, the communication interface 242 is operatively and selectively connected to the processor 244, which is operatively and selectively connected to the user interface 249 and the memory 246. In some embodiments, the user 245 may use the user application 247 to execute processes described with respect to the process flows described herein.

Each communication interface described herein, including the communication interface 242, generally includes hardware, and, in some instances, software, that enables the user input system 240, to transport, send, receive, and/or otherwise communicate information to and/or from the communication interface of one or more other systems on the network 210. For example, the communication interface 242 of the user input system 240 may include a wireless transceiver, modem, server, electrical connection, and/or other electronic device that operatively connects the user input system 240 to another system such as the system 230. The wireless transceiver may include a radio circuit to enable wireless transmission and reception of information.

Each processor described herein, including the processor 244, generally includes circuitry for implementing the audio, visual, and/or logic functions of the user input system 240. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 247 of the memory 246 of the user input system 240.

Each memory device described herein, including the memory 246 for storing the user application 247 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory 246 includes the user application 247. In some embodiments, the user application 247 includes an interface for communicating with, navigating, controlling, configuring, and/or using the user input system 240. In some embodiments, the user application 247 includes computer-executable program code portions for instructing the processor 244 to perform one or more of the functions of the user application 247 described and/or contemplated herein. In some embodiments, the user application 247 may include and/or use one or more network and/or system communication protocols.

Also shown in FIG. 2 is the user interface 249. In some embodiments, the user interface 249 includes one or more output devices, such as a display and/or speaker, for presenting information to the user 245. In some embodiments, the user interface 249 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 245. In some embodiments, the user interface 249 includes the input and display devices of a mobile device, which are operable to receive and display information.

FIG. 2 also illustrates a system 230, in accordance with an embodiment of the present invention. The system 230 may include any computerized apparatus that can be configured to perform any one or more of the functions of the system 230 described and/or contemplated herein. In accordance with some embodiments, for example, the system 230 may include a computer network, an engine, a platform, a server, a database system, a front end system, a back end system, a personal computer system, and/or the like. Therefore, the system 230 may be an external server as described herein. In some embodiments, such as the one illustrated in FIG. 2, the system 230 includes a communication interface 232, a processor 234, and a memory 236, which includes a system application 237 and a datastore 238 stored therein. As shown, the communication interface 232 is operatively and selectively connected to the processor 234, which is operatively and selectively connected to the memory 236.

It will be understood that the system application 237 may be configured to implement any one or more portions of the various user interfaces and/or process flow described herein. The system application 237 may interact with the user application 247. It will also be understood that, in some embodiments, the memory includes other applications. It will also be understood that, in some embodiments, the system application 237 is configured to communicate with the datastore 238, the user input system 240, etc.

It will be further understood that, in some embodiments, the system application 237 includes computer-executable program code portions for instructing the processor 234 to perform any one or more of the functions of the system application 237 described and/or contemplated herein. In some embodiments, the system application 237 may include and/or use one or more network and/or system communication protocols.

In addition to the system application 237, the memory 236 also includes the datastore 238. As used herein, the datastore 238 may be one or more distinct and/or remote datastores. In some embodiments, the datastore 238 is not located within the system and is instead located remotely from the system. In some embodiments, the datastore 238 stores information or data described herein.

It will be understood that the datastore 238 may include any one or more storage devices, including, but not limited to, datastores, databases, and/or any of the other storage devices typically associated with a computer system. It will also be understood that the datastore 238 may store information in any known way, such as, for example, by using one or more computer codes and/or languages, alphanumeric character strings, data sets, figures, tables, charts, links, documents, and/or the like. Further, in some embodiments, the datastore 238 may include information associated with one or more applications, such as, for example, the system application 237. It will also be understood that, in some embodiments, the datastore 238 provides a substantially real-time representation of the information stored therein, so that, for example, when the processor 234 accesses the datastore 238, the information stored therein is current or substantially current.

It will be understood that the embodiment of the system environment illustrated in FIG. 2 is exemplary and that other embodiments may vary. As another example, in some embodiments, the system 230 includes more, less, or different components. As another example, in some embodiments, some or all of the portions of the system environment 200 may be combined into a single portion. Likewise, in some embodiments, some or all of the portions of the system 230 may be separated into two or more distinct portions.

In addition, the various portions of the system environment 200 may be maintained for and/or by the same or separate parties. It will also be understood that the system 230 may include and/or implement any embodiment of the present invention described and/or contemplated herein. For example, in some embodiments, the system 230 is configured to implement any one or more of the embodiments of the process flow 100 described and/or contemplated herein in connection with FIG. 1 or any other process flow described herein. Additionally, the system 230 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator—and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for processing readable indicia for paying a bill associated with a merchant, the apparatus comprising:
a memory;
a processor; and
a computing module stored in the memory, executable by the processor, and configured to:
receive information associated with readable indicia associated with the bill; and
process the readable indicia to initiate one or more options to schedule payment for the bill, wherein the one or more options comprise a first option to pay the bill immediately, a second option to schedule payment of the bill at a predetermined time in the future, a third option to establish an electronic link to the merchant in order to schedule periodic payment of the bill, and a fourth option to present a reminder about the bill at a selected date in the future.

2. The apparatus of claim 1, wherein the readable indicia comprises information associated with the merchant and information associated with the bill.

3. The apparatus of claim 2, wherein the readable indicia comprises an alias associated with the merchant.

4. The apparatus of claim 1, wherein the readable indicia comprises information associated with a financial institution account or a payment card.

5. The apparatus of claim 4, wherein the readable indicia comprises information associated with configuring the financial institution account or an account associated with the payment card based on a selected option to schedule payment for the bill, and wherein the module is further configured to:
receive a user's selection of an option to schedule payment for the bill; and
configure the financial institution account or an account associated with the payment card based on selected option.

6. The apparatus of claim 1, wherein the module is further configured to:
receive a user's selection of an option to schedule payment for the bill; and
initiate scheduling payment for the bill based on the selected option.

7. The apparatus of claim 1, wherein the module is further configured to:
process the readable indicia to initiate an option to switch from paper-based billing to paperless billing.

8. The apparatus of claim 1, wherein the readable indicia comprises a Quick Response (QR) code.

9. The apparatus of claim 1, wherein the readable indicia is comprised in a tag that transmits information wirelessly.

10. The apparatus of claim 1, wherein the apparatus comprises a portable mobile communication apparatus that comprises an image-capturing component, and wherein an image of the readable indicia is captured by the portable mobile communication apparatus, and wherein the processing occurs either inside or outside the portable mobile communication apparatus.

11. The apparatus of claim 1, wherein the readable indicia comprises electronic readable indicia.

12. The apparatus of claim 11, wherein the electronic readable indicia is transmitted via at least one of email, text message, or multimedia message.

13. The apparatus of claim 11, wherein the electronic readable indicia is dynamically generated based on a user's selection of an option to schedule payment for the bill.

14. The apparatus of claim 1, wherein the readable indicia comprises physical readable indicia, wherein the physical readable indicia is printed on paper.

15. The apparatus of claim 1, wherein the readable indicia comprises a first readable indicia and a second readable indicia, and wherein when the module receives first information associated with the first readable indicia, the module is configured to not simultaneously receive second information associated with the second readable indicia.

16. The apparatus of claim 1, wherein the module is further configured to:
receive authentication credentials associated with the payment of the bill; and wherein the module configured to process the readable indicia is further configured to:
process the authentication credentials.

17. The apparatus of claim 16, wherein the authentication credentials are first authentication credentials, wherein second authentication credentials are comprised in the readable indicia, and wherein the module is further configured to:
extract the second authentication credentials from the readable indicia; and
determine whether the first authentication credentials match the second authentication credentials.

18. The apparatus of claim 16, wherein the module is configured to:
determine whether the authentication credentials match second authentication credentials accessed by the apparatus.

19. A method for processing readable indicia for processing readable indicia for paying a bill associated with a merchant, the method comprising:
receiving information associated with readable indicia associated with a bill; and
processing the readable indicia to initiate one or more options to schedule payment for the bill, wherein the one or more options comprise a first option to pay the bill immediately, a second option to schedule payment of the bill at a predetermined time in the future, a third option to establish an electronic link to the merchant in order to schedule periodic payment of the bill, and a fourth option to present a reminder about the bill at a selected date in the future.

20. A computer program product for processing readable indicia for processing readable indicia for paying a bill associated with a merchant, the computer program product comprising:
a non-transitory computer-readable medium comprising a set of codes for causing a computer to:
receive information associated with readable indicia associated with a bill; and
process the readable indicia to initiate one or more options to schedule payment for the bill, wherein the one or more options comprise a first option to pay the bill immediately, a second option to schedule payment of the bill at a predetermined time in the future, a third option to establish an electronic link to the merchant in order to schedule periodic payment of the bill, and a fourth option to present a reminder about the bill at a selected date in the future.
